(19) United States
(12) Patent Application Publication
(10) Pub. No.: US 2012/0072252 A1
(43) Pub. Date: Mar. 22, 2012

(54) TALENT MANAGEMENT DASHBOARD

(75) Inventors: Chris Deegan, Monrovia, MD (US); Vance Brahosky, Springfield, VA (US); Beverly Bradley-Topping, Upper Marlboro, MD (US); Joseph Blair Parsons, III, Fredericksburg, MD (US); Randall Miller, King George, VA (US)

(73) Assignee: Government of the United States of America, Washington Navy Yard, DC (US)

(21) Appl. No.: 13/233,901

(22) Filed: Sep. 15, 2011

Related U.S. Application Data
(60) Provisional application No. 61/384,392, filed on Sep. 20, 2010.

(51) Int. Cl. G06Q 10/00

(52) U.S. Cl. 705/7.11

(57) ABSTRACT

A dashboard is developed to assess the ability of workers in an organization to accomplish one or more goals of the organization. The dashboard permits defining one or more competencies employees in the organization are required to have, and defining a skill set for each competency. Each skill set has one or more skills the employees are required to have to carry out each competency. Each skill under each competency for each employee is rated according to degree of experience in that skill. A discrete skill level in each competency for each of the employees is determined or calculated from the above rating information. Once the rating information is processed, the information can be instantaneously displayed in various viewing formats to give a snapshot look at the breadth of skill in the organization.

### FIELD OF THE INVENTION

The disclosure relates generally to a dashboard for managing employee information and leveraging that information to meet one or more goals of an organization.

### BACKGROUND OF THE INVENTION

Organizations want to become more efficient. One of the ways to do this is to capitalize on the strengths and weaknesses of a workforce. Having a fuller understanding of the capabilities within an organization allow for staffing projects more effectively with the personnel having the right qualifications. It enables wiser hiring decisions and enables growing the workforce by facilitating the development conversation at annual review time. It also softens the hit an organization takes when losses occur through attrition, because succession planning can be initiated.

### SUMMARY OF THE INVENTION

A method for using a display unit of a computing system for assessing the ability of workers in an organization to accomplish one or more goals of the organization is provided. The method includes defining one or more competencies employees in the organization are required to have, defining a skill set for each competency, each skill set having one or more skills the employees are required to have to carry out each competency, rating each skill under each competency for each employee, determining a discrete skill level in each competency for each of the employees, and displaying a graphic on the display unit which illustrates the proportion of the employees at each discrete skill level.

In another embodiment, a tangible computer readable medium storing computer executable code that when executed by one or more central processing units enables assessing the ability of workers in an organization to accomplish one or more goals of the organization is also provided. The computer executable code enables defining one or more competencies employees in the organization are required to have, defining a skill set for each competency, each skill set having one or more skills the employees are required to have to carry out each competency, rating at least one skill under each of the competencies for each employee, determining a discrete skill level in each competency for each employee, and displaying a graphic on the display unit which illustrates the proportion of the employees at each discrete skill level.

In yet another embodiment, a system for assessing the ability of workers in an organization to accomplish one or more goals of the organization is provided. The system includes a control unit. The control unit includes a central processing unit, an input device and an output device. The control unit is configured to execute computer readable code configured to define one or more competencies employees in the organization are required to have, define a skill set for each competency, each skill set having one or more skills the employees are required to have to carry out each competency, to rate at least one skill under each of the competencies for each employee, determine a discrete skill level in each competency for each employee, and display a graphic on the display unit which illustrates the proportion of the employees at each discrete skill level, wherein the control unit further comprises a memory unit configured to store data therein retrievable by the central processing unit. The input device is in communication with the control unit and is configured to accept user supplied data. The output device is in communication with the control unit and configured to display data stored in the memory of the memory unit.

### BRIEF DESCRIPTION OF THE DRAWINGS

FIG. 1 illustrates an example embodiment of an employee interface view of the Talent Management Dashboard;

FIG. 2 is an enlarged view of a portion of the interface shown, in FIG. 1. and illustrates the detailed view of the skills that are available for rating;

FIG. 3 illustrates an example embodiment of a manager interface of the Talent Management Dashboard showing the employees pending;

FIG. 4 illustrates a manager's view of detailed employee information;

FIG. 5 illustrates graphic showing the proportion of workers at discrete skill levels;

FIG. 5a illustrates the ability to manipulate the employee tree to add and delete employees;

FIG. 5b illustrates the ability to search for employees meeting specified requirements;

FIG. 6 illustrates the ability to view multiple graphs corresponding to different managers at the same time;

FIG. 7 illustrates pie graphs showing the skill level in skills under the Military competency;

FIG. 8 illustrates bar graphs showing the skill level in skills under the Military competency;

FIG. 9 illustrates a summary report showing the breakdown of discrete skill levels according to manager and for the selection of All Competencies;

FIG. 10 illustrates a summary report of the discrete skill level according to skills;

FIG. 11 illustrates graphs showing employees grouped by discrete background information;

FIG. 12 illustrates the information shown in FIG. 11 but in table form;

FIG. 13 illustrates a status metrics report;

FIG. 14 illustrates a process flow diagram of the employee interaction with the Talent Management Dashboard; and

FIG. 15 illustrates a computing system for accessing the ability of workers.

### DETAILED DESCRIPTION

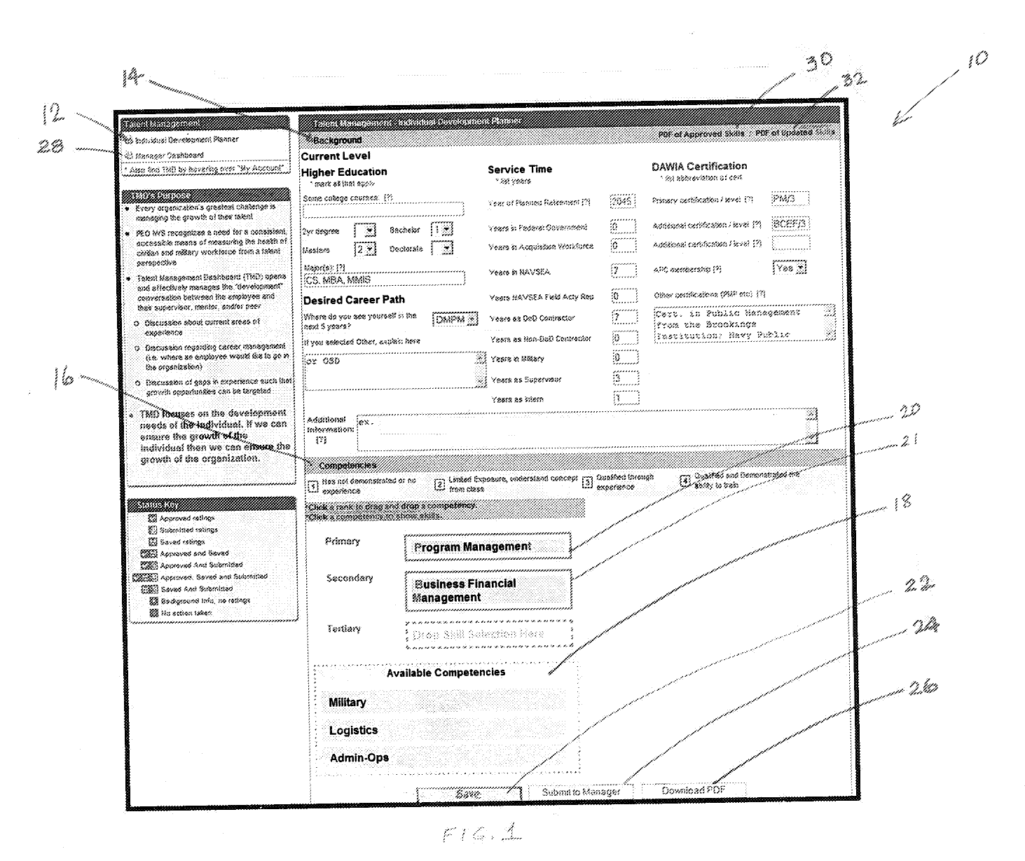

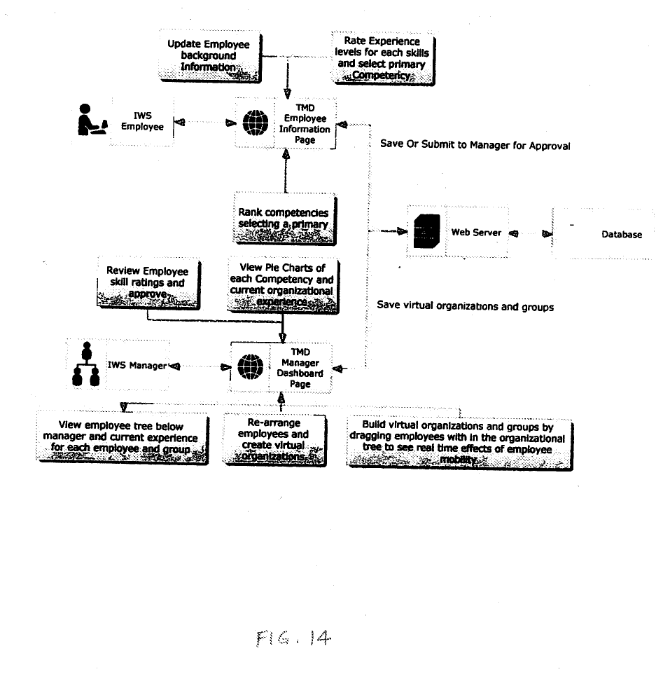

The Talent Management Dashboard (“Dashboard”), shown in FIGS. 1-15, captures an amount and type of experience and training resident within an organization at an individual level, so that this information may be used to make better informed human capital resource management decisions. The Dashboard is useful for both military and civilian employees as well as management and non-management. On an individual level, a worker can use the tool to view their own personal experience level in a particular area, and to identify areas an area in which further training is desired or needed. Managers may use the Dashboard to view an overall experience level resident within an organization. The organizational experience level may be viewed by looking at results or statistics for the overall organization, whether for hundreds of employees or for thousands, or by drilling down to the individual level to look at an individual's specific statistics. More specifically, the statistics associated with a particular competency area, category or skill may be viewed, as well as the impact on the statistics as a result of attrition, retirement, or other movement in, out of and within the organization. The Dashboard allows for building virtual teams composed of workers with a selected set of skills, and then instantly viewing that new team along with its associated strengths and weaknesses. In this way, staffing projects with the appropriate personnel can be completed within a short turnaround time.

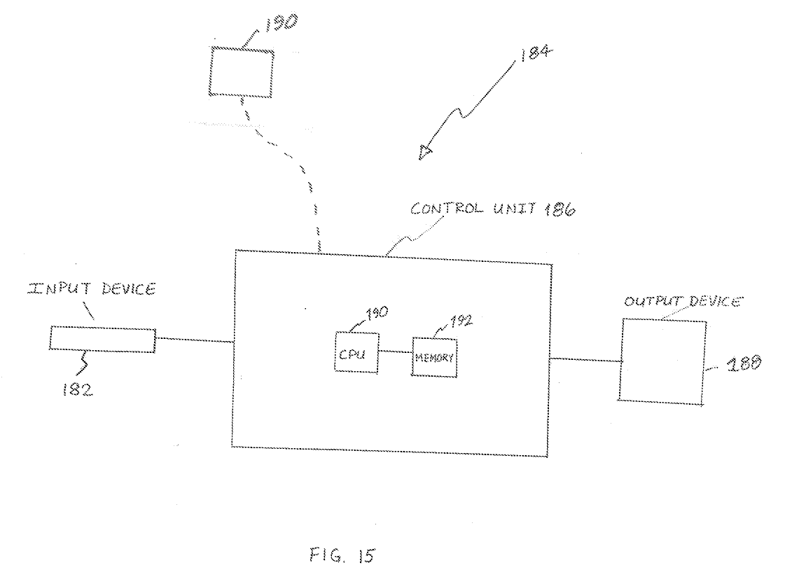

More specifically, the Dashboard enables defining one or more competencies employees in the organization are required to have and defining a skill set for each competency, wherein each skill set has one or more skills the employees are required to have to carry out each competency. It further enables rating each skill under each competency for each employee, determining a discrete skill level in each competency for each of the employees, and displaying a graphic on the display unit which illustrates the proportion of the employees at each discrete skill, level. The Dashboard is accessible through a display unit 188 of a computing system or general purpose computer 184. The computing system 184 may, for example, include a control unit 186 in communication with an input device 182 such as a keyboard or mouse, for inputting information, and in further communication with an output device 188 such as the display unit or monitor, as shown in the example of FIG. 15. The control unit 186 may include a central processing unit 190 in communication with a memory unit 192. The Dashboard 10 may be stored on a tangible computer readable medium 190. The computer readable medium 190 is a storage device such as cd disk or dvd that may be put in communication with the computing system 184 by way of an interface device such as a cd rom drive that may be included in the computing system 184 and which can access the Dashboard stored on the computer readable medium 190. The Dashboard 10 includes computer executable code. When the computer executable code is executed by one or more central processing units 190, the ability of workers in an organization may be assessed to accomplish one or more goals of the organization. The Dashboard 10 can access and process employee data and then graphically display the competencies and skills of one or more employees of the organization. Data means the same as information, and these terms are used interchangeably. This processing and displaying of data can be done essentially instantly. It is to be understood that it takes time to run the program and process the data, but practically speaking the data may be processed in such a short period of time that for all practical purposes we can consider it to be done instantly.

In an employee view of the Dashboard 10, as shown for example in the embodiment illustrated in FIG. 1, an Individual Development Planner (“IDP”) 12 or another information intake form is used to capture relevant data about an employee's pedigree (both academic and experience based). Multiple employees can simultaneously enter their information into the Dashboard 10, and the Dashboard 10 can update all of that information automatically. The form may be used to open, document and manage a “development” conversation between an employee and a manager. The manager may use the form as a basis for initiating a conversation about a current area or level of experience, discussing gaps in experience such that training opportunities can be targeted, or discussing career management, i.e., where an employee would like to move within an organization or be in 5 years.

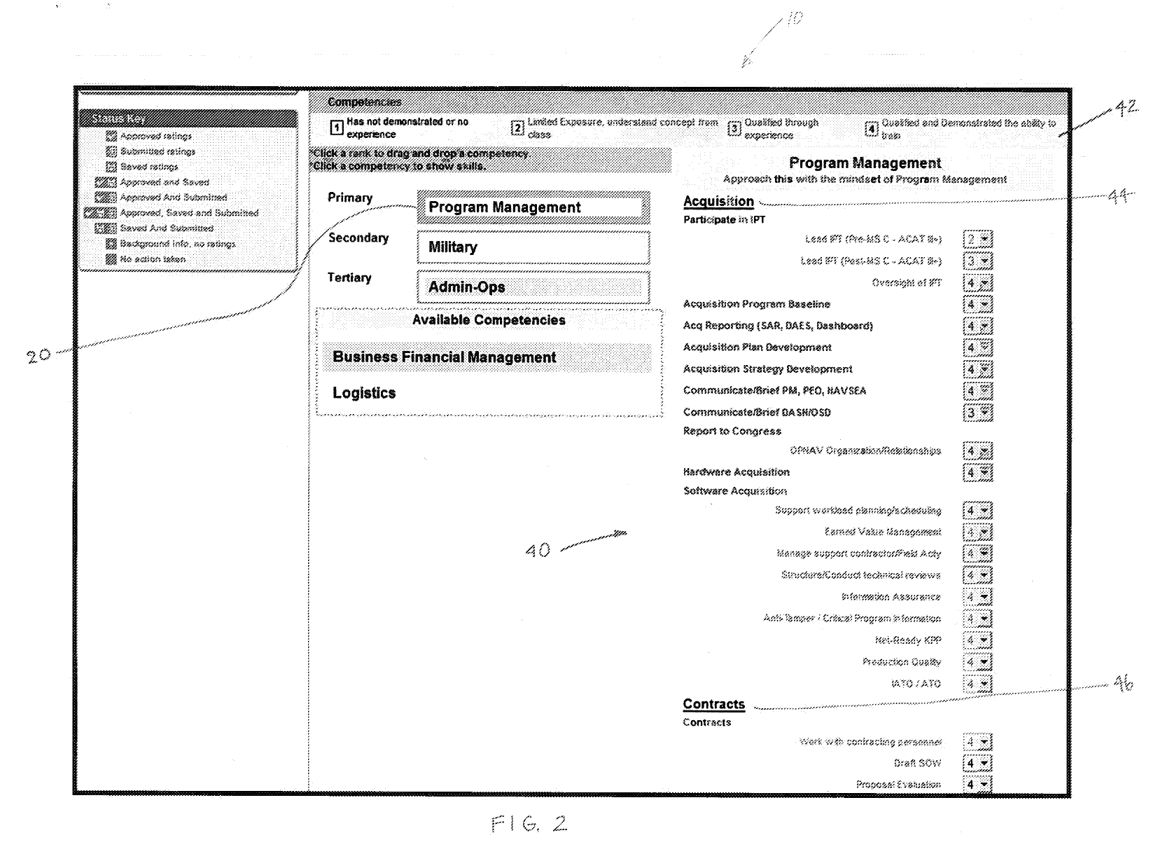

In the Background section 14 of the IDP 12, space is provided for employees to fill in background information and relevant aspects of an employee's career to automatically build a database that is instantly graphically viewable. Some categories of information captured in this section may be service time, desired career path, education or certifications, etc. Space is also provided to add any additional information the employee thinks is relevant but not captured on the form. If clarification is needed for parts of the form, a user moves their mouse pointer over the question mark icon [?] and a help bubble pops up with helpful information, such as a definition of a term. In a Competencies section 16, competencies needed to be competent in a job position are identified. In the example of FIG. 2, five competencies are identified. There may be five competencies, two competencies, or any number of competencies identified. The five competencies shown are Program Management, Business Financial Management, Military, Logistics, and Admin-Ops. Of these, Program Management is assigned a Primary rank, which indicates that, this is considered to be the employee's primary competency. Each of the competencies is shown in dotted box 18. Competencies are selected from the box 18, and then clicked and dragged to one of the primary, secondary or tertiary positions. As shown in the figure, Program Management has been moved to box 20 for the primary competency. Business Financial Management has been moved to box 21 for the secondary competency, and the tertiary box is left blank. In this manner, the employees rank what they consider to be their strongest three competencies. It should also be noted that if one were to click on the competency in box 20, then the set of skills related to the competency, would pop up to the right of the competency, as shown below in FIG. 2.

All of the background information and ranking information input into the IDP 12 may be saved to the Dashboard 10 by selecting the save link 22 and submitted to the manager for approval or concurrence by selecting the submit link 24. The IDP page may be created into a PDF form and downloaded by selecting link 26. The screenshot shown in FIG. 1 is the employee page view, but since this view was accessed by someone acknowledged within the Dashboard 10 as being in a managerial position, an additional navigation option is available on the left of the screen, a Manager Dashboard link 28. Two additional options 30, 32 appear to the right of the screen. These are options to create a PDF of Approved Skills and to create a PDF of updated but not yet approved skills, but again note that these additional options are only viewable to the user entering their IDP 12 information.

As shown in FIG. 2, clicking on a competency reveals a pop-up menu 40 of skills associated with that particular competency. Each of the competencies are color coded based on a skill rating or overall rating taken of all the ratings of the skills under the particular competency. For example, the Program Management competency in box 20 may be highlighted in yellow, according to the designated color coded legend 42, to reflect the skill ratings associated with that competency. An update to a skill or competency results ink an updated rating and color. If a user enters the page with saved/submitted skills, then the competencies will be pre-colored with their score.

Under the competency Program Management, skills are divided into categories, such as Acquisition 44 and Contracts 46. There are more categories under the competency Program Management than just the two showing in this partial screen shot. Under the category of Acquisition, the following skills are listed: Participate in IPT, Acquisition Program Baseline, etc. Each of the skills is rated by the employee, and submitted for concurrence by the manager, or the manager can rate the skills for the employee. The skills are rated from 1 to 4 in accordance with a stated legend 42. In this particular legend, a rating of “1” equals no experience or not demonstrated. A “2” equals limited exposure or understand concept from class. A “3” equals qualified through experience, and a “4” equals highly qualified and demonstrated the ability to train. Each rating in the legend is preferably associated with a unique color for a quick visual determination of the rating. Other legends may be adopted. Instead of color, the ratings may be highlighted with another highlighting method, such as cross-hatching, diagonal lines, circles, any other selection of colors, etc. The ratings are savable for later viewing and submittable to the manager for approval, as previously discussed by clicking on links 22 and 24, shown in FIG. 1.

An experience rating may be calculated from the ratings by averaging all of the ratings under a competency. The resulting average then becomes the experience rating associated with that competency. The average is calculated on a per employee basis for each of an employee's competencies, and a separate average is calculated to generate an overall experience rating for all employees under a competency. Skills and category of skills may also be similarly averaged. The average may or may not be visible to the individual employee in the employee view, but may be viewable in the management view of the Dashboard 10. All this data collected and calculated is instantly viewable in various graphical formats for analysis, as shown in the remaining figures. Although a numerical average is calculated in this embodiment, it is also possible to use alternative numerical representations such as a median number as a means for making the same kinds of evaluations and analyses.

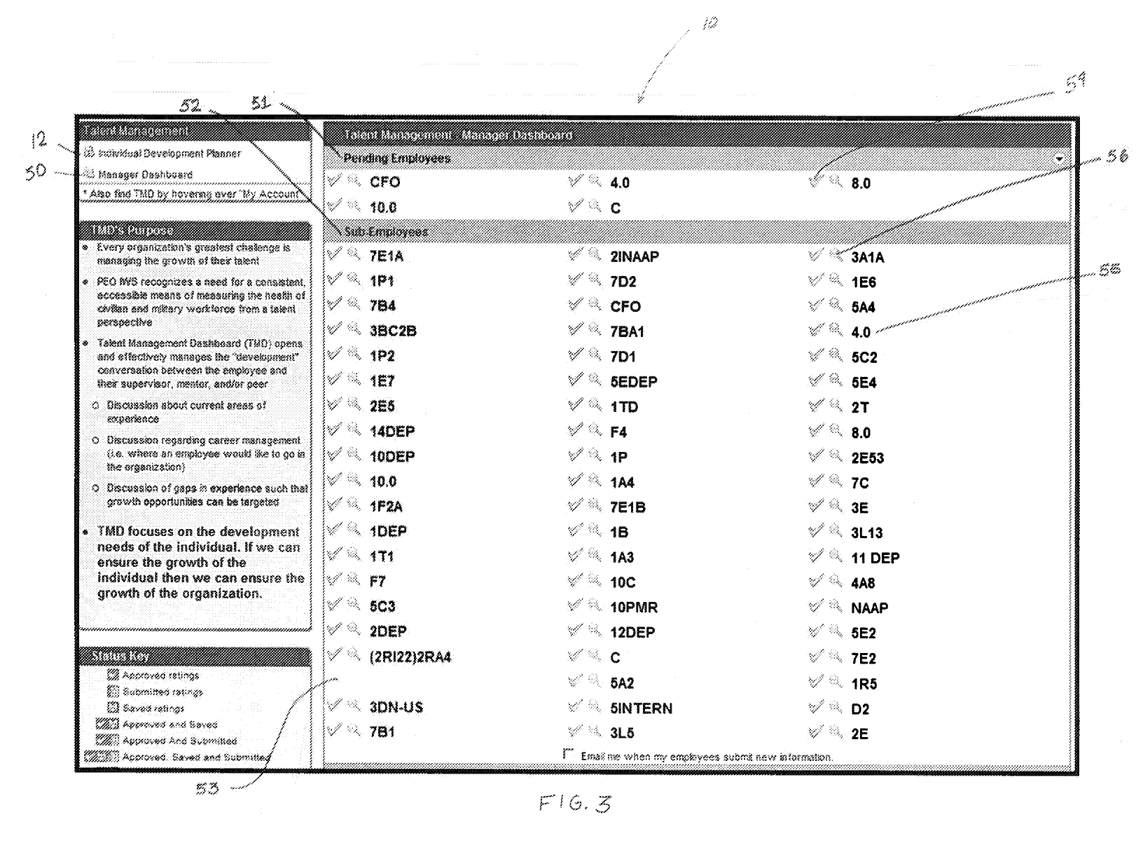

In an exemplary view of the Manager Dashboard shown in FIG. 3, only managers see link 50 which indicates that the Dashboard 10 is in the manager view. There is also link 12 to the IDP so that a manager user can go back and forth between the different views. In this view, employees who have submitted changes are shown in list 51 as pending employees. The Manager Dashboard shows the manager's pending employee approvals in a multi-column layout. The first group of employees under the pending employees 51 are those employees that have subordinates, in other words, other managers that the manager oversees. Under this list is a sub-employees list 52, which shows all of the subordinates of the manager. Employees in the manager's direct chain of command are separated by space 53 from employees outside the manager's direct chain of command but whom the manager is still able to approve. This is possible because a manager can be granted permission in the Dashboard 10 to view/manage other parts of an organizational structure outside of their own chain.

The checkmark 54 next to the employee's name indicates that the manager needs to take an action with respect to that pending employee. Other indicators other than a checkmark may be used. In this example, instead of revealing individual names, the organizational code for an employee's position is used, which is a unique employee identifier, as code 7E1A or 1P1 in the first column of 52.

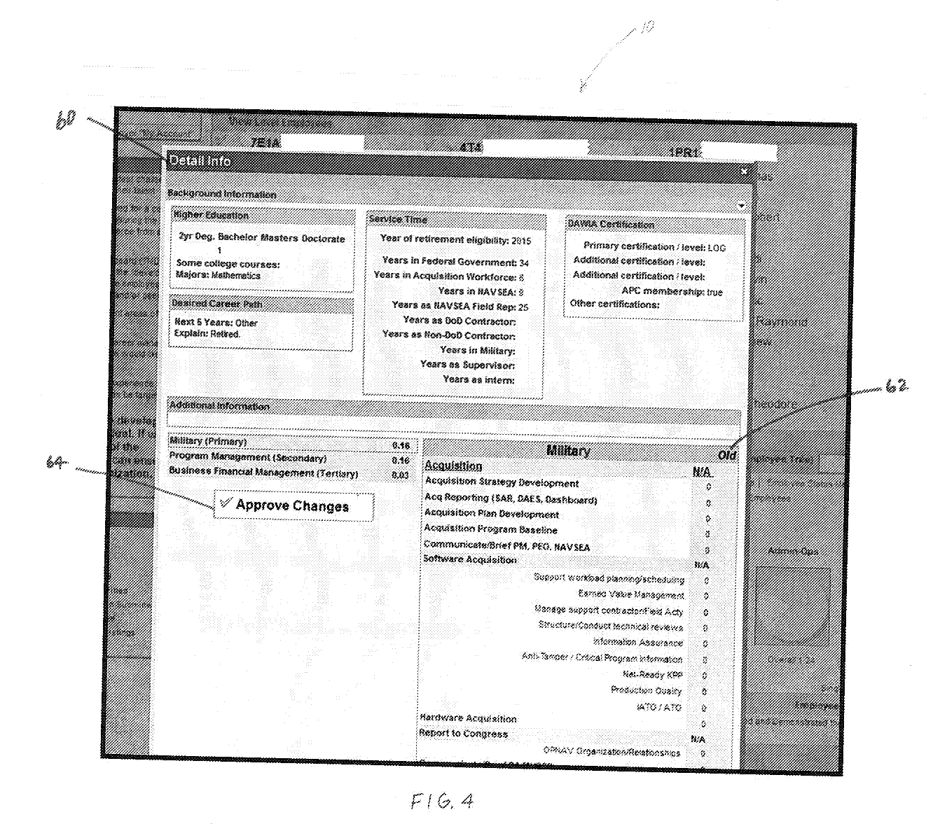

Changes need to be approved, before the changes can be accepted into the Dashboard 10 for use as a graphable data point. There is an option to make a closer inspection of the changes waiting approval which is indicated by magnifying glass 56, near each pending employee's name. To view the changed or updated information, the manager selects the magnifying glass 56 and a more detailed view 60 of the individual employee's information, shown in FIG. 4, pops up.

In this detailed view 60, the manager can view the changes and updates made to an employee's profile or IDP, and the manager can approve the changes. Where values have changed, old values are shown in the column 62 labeled Old. When the manager is satisfied with the changes, the manager can select the Approve Changes box 64.

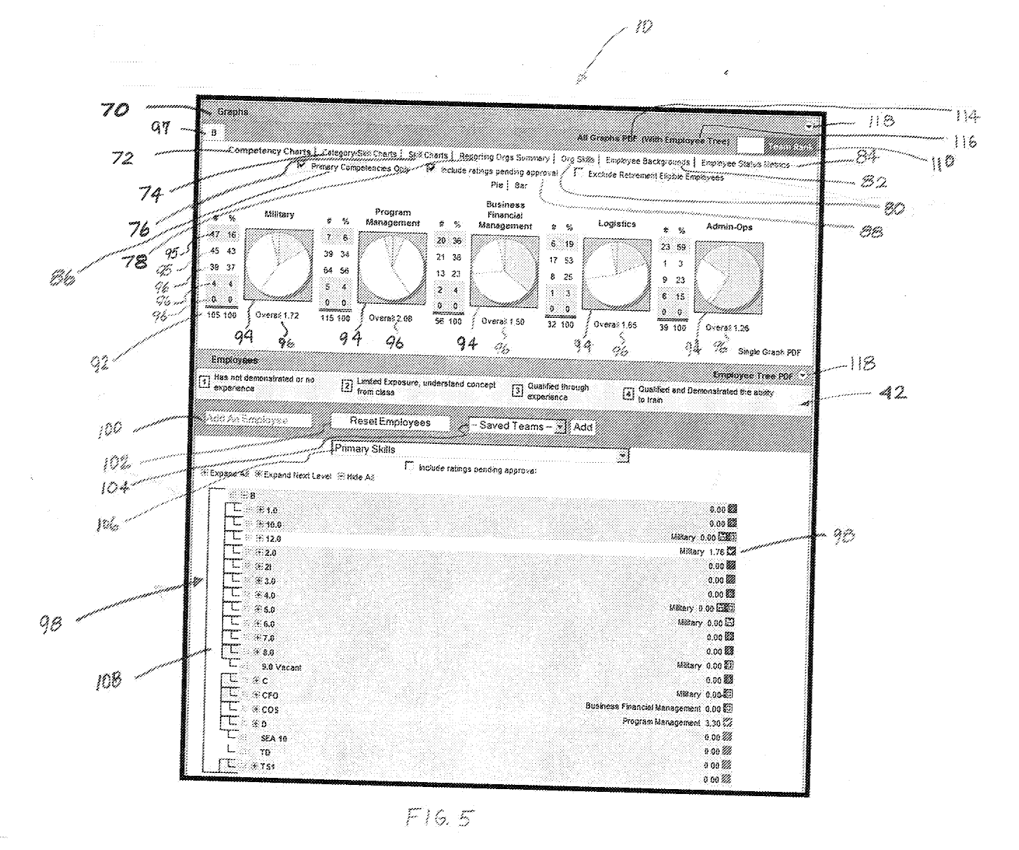

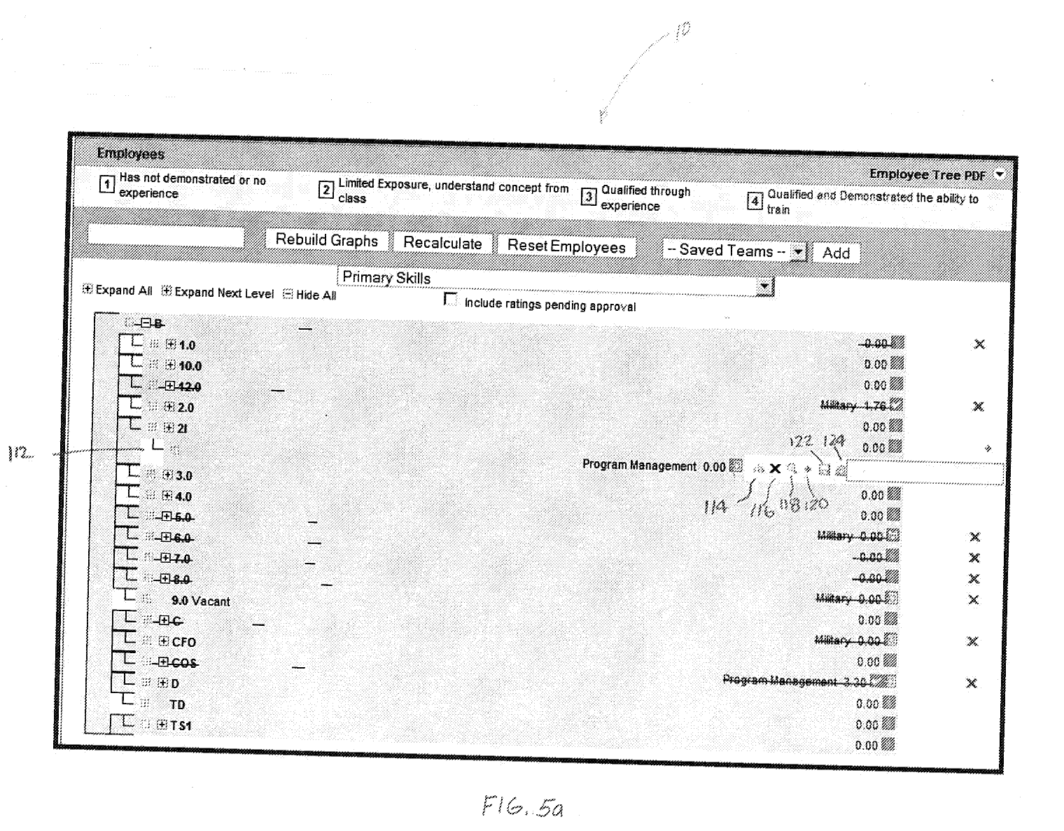

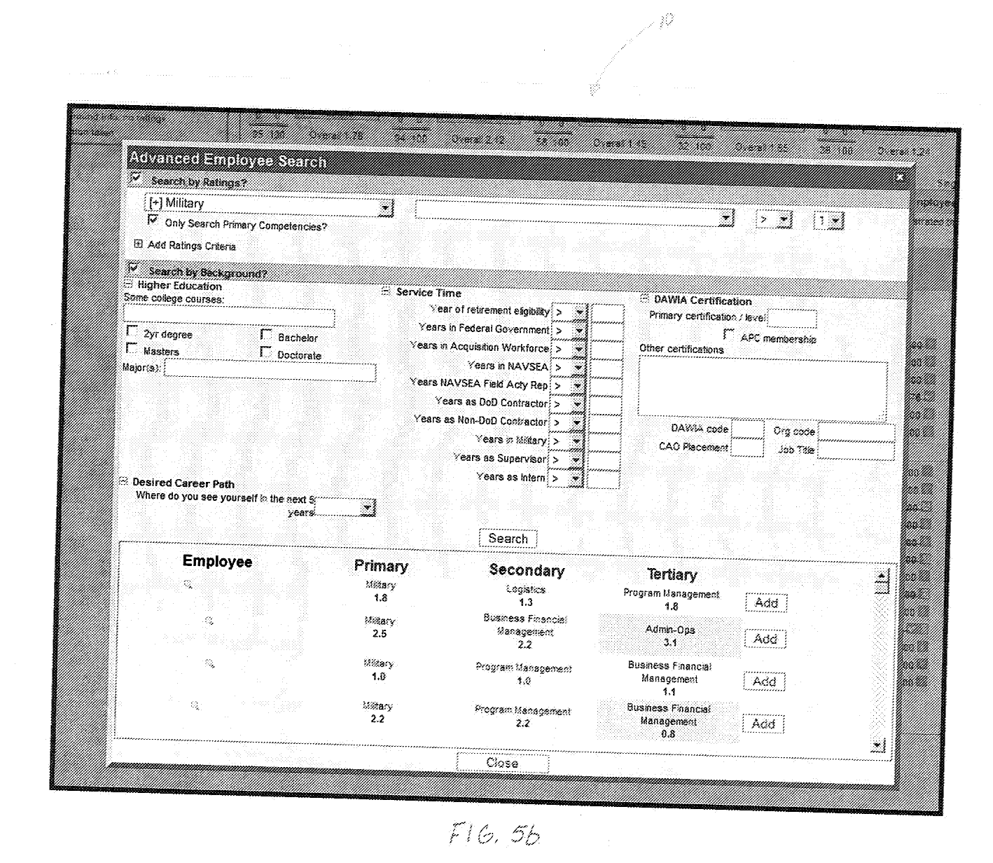

In another view, the Manager Dashboard view 70 may be set as the default setting that automatically opens up when the dashboard is accessed. The data stored in the Dashboard 10 may be displayed in graphical form, as shown in FIG. 5. In the example embodiment shown in FIG. 5, selecting graphing option 72 displays those workers who have selected a primary competency and then displays their skill rating in pie or bar chart form, depending on what the user selects. There are various graphing options shown. Of course, the tool 10 can be programmed to display the information differently. Options for Competency Charts 72, Category/Skill Charts 74, Skill Charts 76, Reporting Orgs Summary 78, Org. Skills 80, Employee Backgrounds 82 and Employee Status Metrics 84 are shown. There are additional filtering options such as to display by Primary Competencies Only 86 and Include ratings pending approval 88. In FIG. 5, Primary Competencies Only 86 and Include Ratings. Pending Approval 88 are selected. The overall rating for all employees who have identified a selected competency, as a primary competency is calculated and averaged and shown beneath the graphs. There is a separate graph for each competency. Beside graphs 94 are tables 92 showing the number of the workers who have rated that competency as their primary competency and showing them grouped according to the skill level they assigned to it. The first table shows that zero workers representing 0% of the total number of workers identified Military as their primary competency and rated the competency a 4. We know that they rated it a 4, because that line in the table is color coded to the legend 42. So the color used to highlight that row is the same color used in the legend for a rating of 4. In this embodiment of the tool 10, the row is color coded, but it may be highlighted using another marking or indicator method such as cross-hatching, diagonal lines, or circles, etc. The highlighting should be consistent with the highlighting chosen for the rating legend 42. Similarly, in the next line, 4 workers representing 4 percent of the total workers who have identified Military as their primary competency have rated Military with a 3, the same color that is used to highlight that row in the table and also used on the pie chart to show 4 percent of the pie. The rest of this table is generated the same way. It should be noted that pie charts are only one of many ways to display the data for user consumption.

In the following way, the ratings 95 are determined. A rating scheme is selected. In the embodiment of FIG. 5, it is predetermined that a score that falls between two numbers will be rounded down. For example, if the average of an employee's ratings under a particular competency is a number between 1.0 and 1.9, the score will be rounded down to 1, for not demonstrated or no experience. Alternatively in another embodiment, if the average rating was 1.51 or above, that rating could be rounded up to a 2. The cut offs and rounding and rounding that occurs is a customization that could be implemented into the tool 10. Then, all of the 1's 2's, 3's and 4's are counted, categorized and graphed. Averages can also be calculated of everyone's ratings for a particular competency to establish an overall rating 96, as shown beneath the pie chart charts. For employee B 97, the average overall rating of his subordinates for the primary competency Military is 1.72.

Other information contained in the management view includes an expandable employee tree 98. The employee tree displays all employees and groups under a manager including vacant positions. The tree can be expanded down to its lowest branch or contracted up to its top branch. The expansion and contraction of the employee tree is accomplished by clicking on the tree. Employees may be added into the employee tree 98 by clicking on the Add An Employee link 100 to create a new position outside the current tree 98 that can then be moved to its, proper position within the tree 98. Then, as shown in FIG. 5a, as will be discussed in more detail below, a search can be conducted to find an employee with specific strengths and weaknesses to fill that branch of the tree 98. A manager may click and drag, drop and move employees in, out, and around the employee tree. In this way, virtual teams can be instantly created, and the skill profile, indicating strengths and weaknesses, of the team can be instantly viewed and assessed. A manager can create a virtual team at the same time that multiple employees are entering their information into the Dashboard 10, and all of this information together can be simultaneously and automatically processed by the Dashboard 10. The ability to make these kinds of modifications to the employee tree 98 gives managers the ability plan for current and future organizational needs, and to conduct sensitivity analyses, for example. If one wants to go back to the original tree 98, then reset option 102 may be selected. When the tree is finished being adjusted, select link 122 when hovered over the adjusted team to save.

Within the tree 98, each employee's name is expandable to view more detailed information about the employee. By clicking on the magnifying glass 118, the employee's specific skill ratings pop up along with accessible background and other information contained in their individual development planner, shown in FIG. 1.

Each employee in the tree is color coded or highlighted for quick identification of the rating associated with that employee's skill in their primary competency, if filtering option 106 is selected. The tree is colored by an employee's associated skill rating in their primary competency, but the tree may also be colored based upon a specific competency, or even a single skill under a selected competency. Even the area 108 within the tree 98 corresponding to the overall group may be color coded to reflect the skill rating associated with the group overall according to the filtering option 106 selected. This overall rating could be considered to be a Team Rank 110. The color coding or highlighting enhances the manager's ability to search through their employees to quickly find the level of skill or experience they are looking for in a particular area.

In FIG. 5a, under employee 21, there is a new branch being added to the tree at position 112. To the right, a series of symbols are displayed. These same symbols appear when any employee in the tree 98 is selected by hovering the mouse cursor over the position in the tree. An organizational tree icon 114, an X 116, a microscope 118, a plus sign 120, a save symbol 122 and an advanced search icon 124. The tree icon 114 is a link to open the graph tab for the organizational level currently selected. The delete icon X 116 is selected to remove an employee from a team for the purpose of group calculations, this helps for determining succession planning and is undone when the reset link 102 in FIG. 5 is selected. The microscope 118 is selected to see more details of an employee's background as shown in FIG. 4. The plus sign is selected to search for and add an employee at this point in the organizational tree. The save icon 122, saves the selected organization level as a virtual team that is created when an employee is selected to fill this branch of the tree 98, and the advanced search icon 124 brings up the view shown in FIG. 5b. The advanced search allows a manager to search on detailed criteria and find exactly the individual or individuals they are looking for to add to their team.

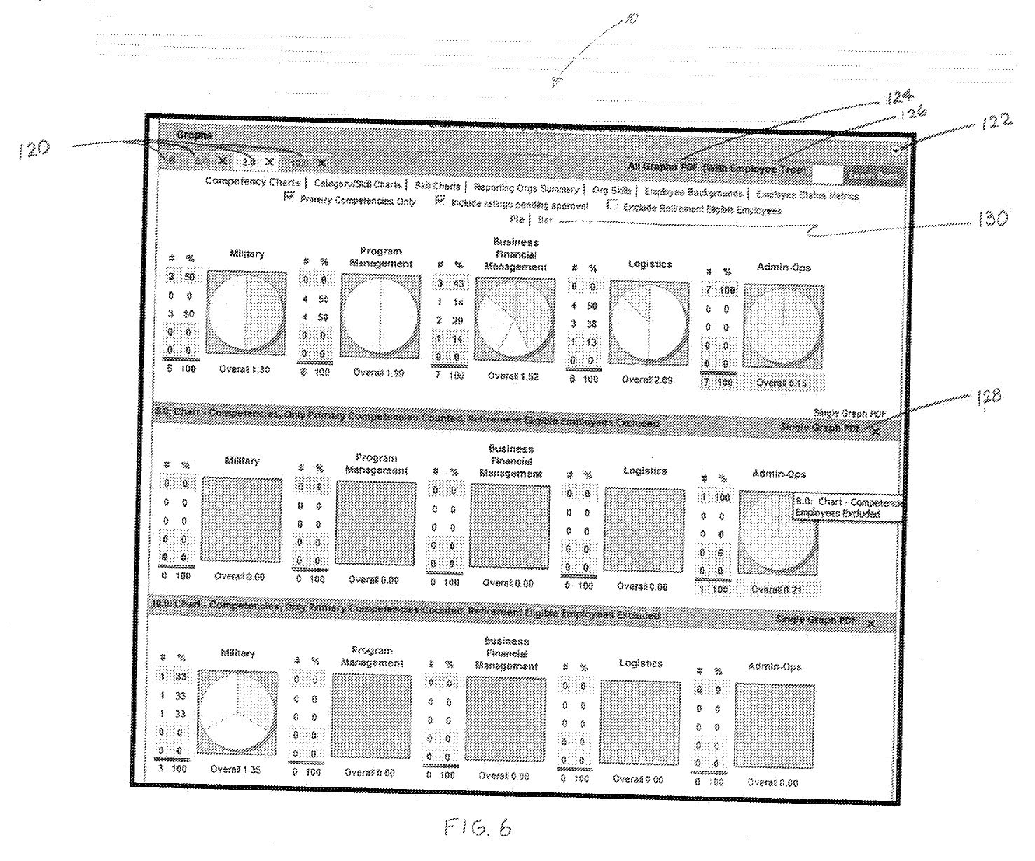

FIG. 6 shows the competency charts for the employees 110 designated as B, 8.0, 2.0, and 10.0. It is possible to tab through these different pages. Each of these particular employees has subordinates beneath them, and the charts associated with their employees can be opened and pinned to the opened page. Pinning is accomplished by shift-left clicking the graphing view you are looking at, and then duplicating or pinning the graph to the bottom of the view, as is done for employees 8.0 and 10.0. In this way, the charts may be opened and compared. Optional features can be added to enhance the user friendliness of the tool 10, such as the downward arrow 122 which is used to minimize that section of the page, or the option 124 to make a PDF document of all of the graphs, and the option 126 to include the employee tree with the PDF. There is also a link 128 to prepare a single graph PDF of the selected chart. There is also the filtering option 130 to organize the data into pie or bar graphs.

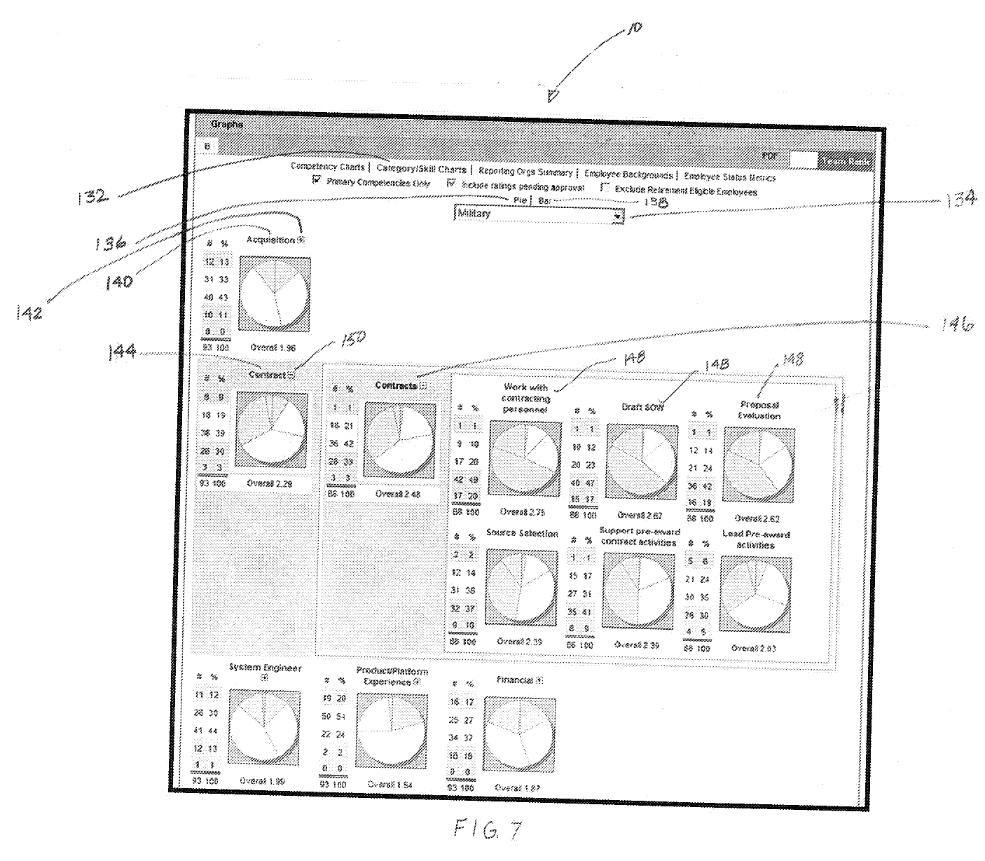

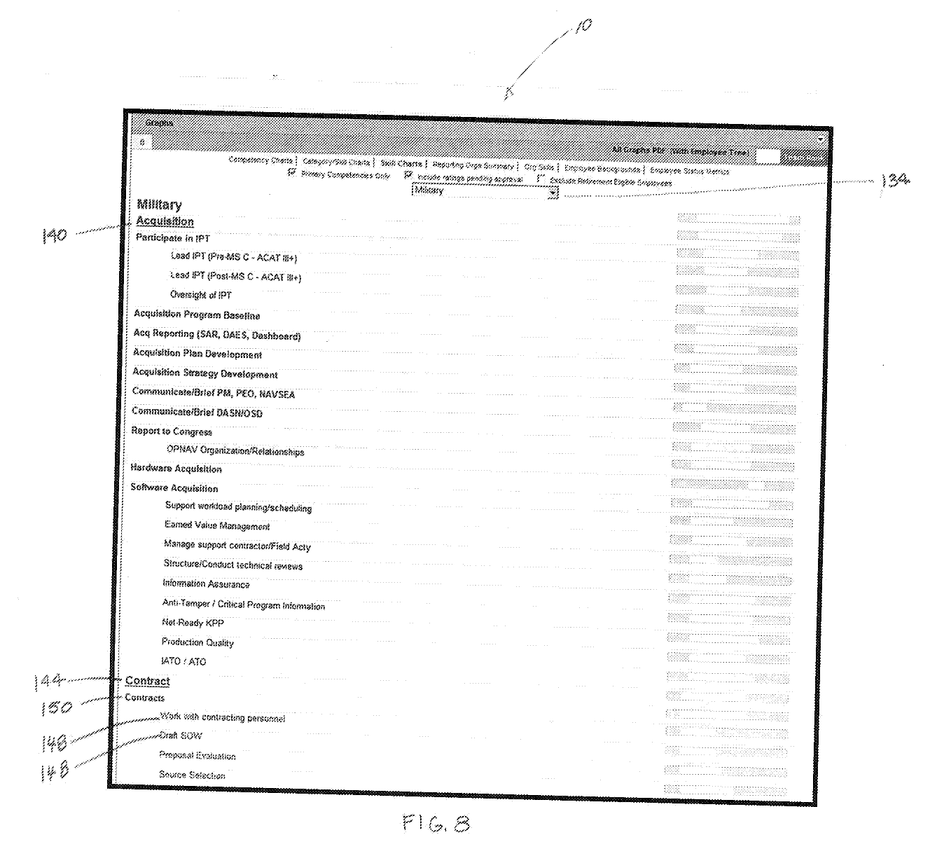

FIGS. 7 and 8, show the data for a selected competency further organized into category and skill charts, as shown by link 132. In FIG. 7, the graphs are shown for the Military competency, selected from drop down menu 134. The graphs are displayed in pie chart form by selecting the filtering option 136. There is also the option to display the data as a bar graph by selecting option 138. Each category, for example the category 140 of Acquisition under the competency of Military is displayed as a graph, and if the plus sign 142 is selected, the category expands, and the graphs associated with each of the subcategories beneath the category is shown. For example, for the category of Contract 144, the graphs associated with the subcategory of Contracts 146 is shown, and a graph for each skill 148 under the category is also displayed. The displays can be contracted by selecting the minus sign 150.

FIG. 8 is an example of same information shown in FIG. 7, but in bar graph form and displayed in the same manner as the IDP FIG. 2 for better visual comprehension.

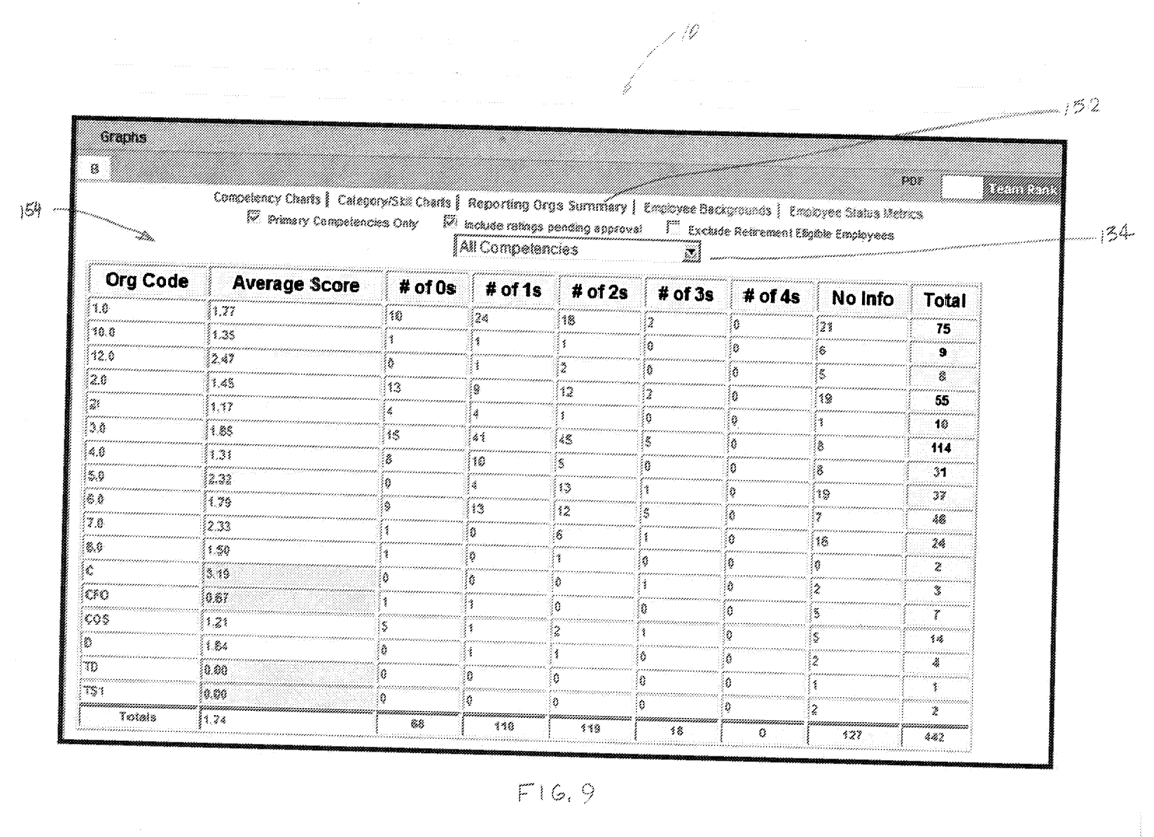

FIG. 9 is an example of the reporting organizations summary view 152. In the drop down menu 134 All Competencies is selected. Then, for each employee, or subgroup within the larger organization, a breakdown 154 of the ratings is displayed. In FIG. 9, the data is shown for four hundred forty two employees (as indicated in the last line of the Total column) which highlights the ability of the Dashboard 10 to reduce large amounts of data and display the data instantly and simultaneously.

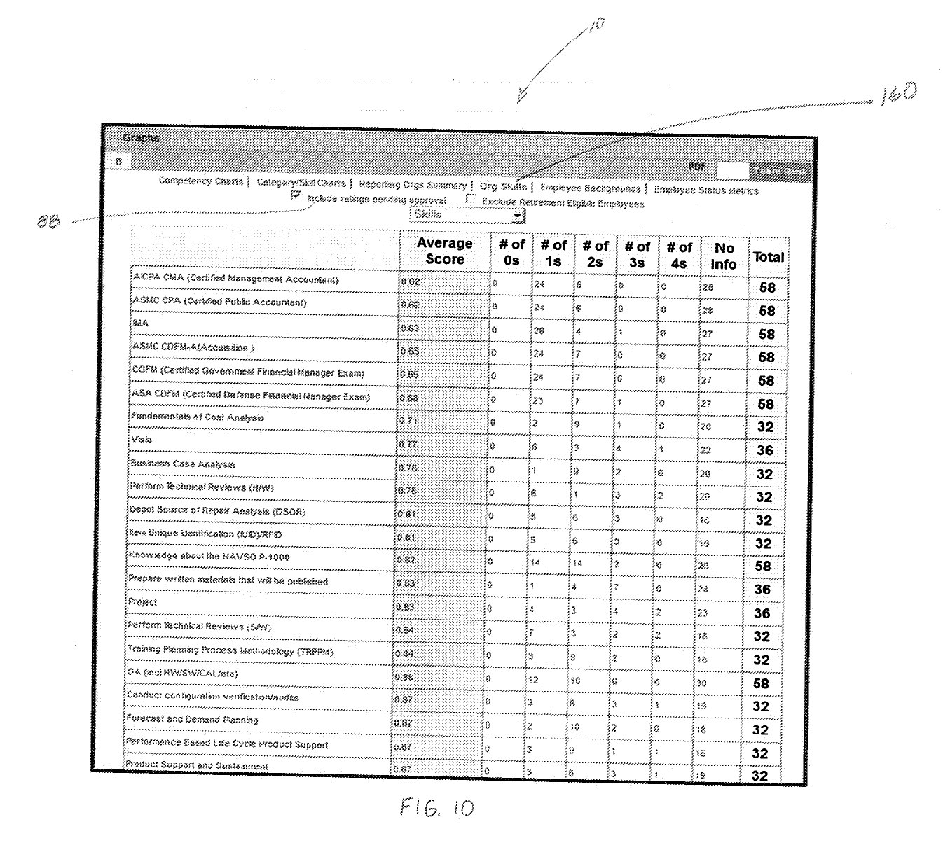

The next selectable chart is the Org Skills chart 160, shown in FIG. 10. Here a breakdown of the ratings at the skill level is given. Notice the option to filter the information or modify the metrics by including pending ratings 88. Other filtering options are possible depends on an organization's needs. This chart organizes the skills and their associated ratings from weakest to strongest, though that order could be reversed.

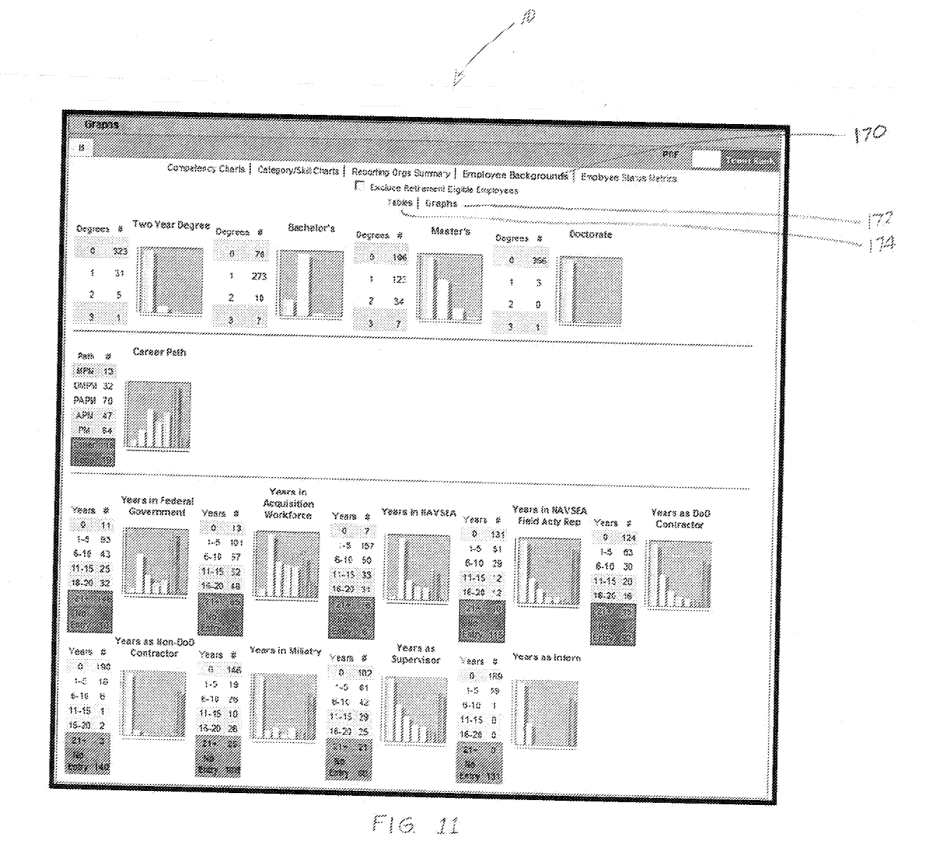

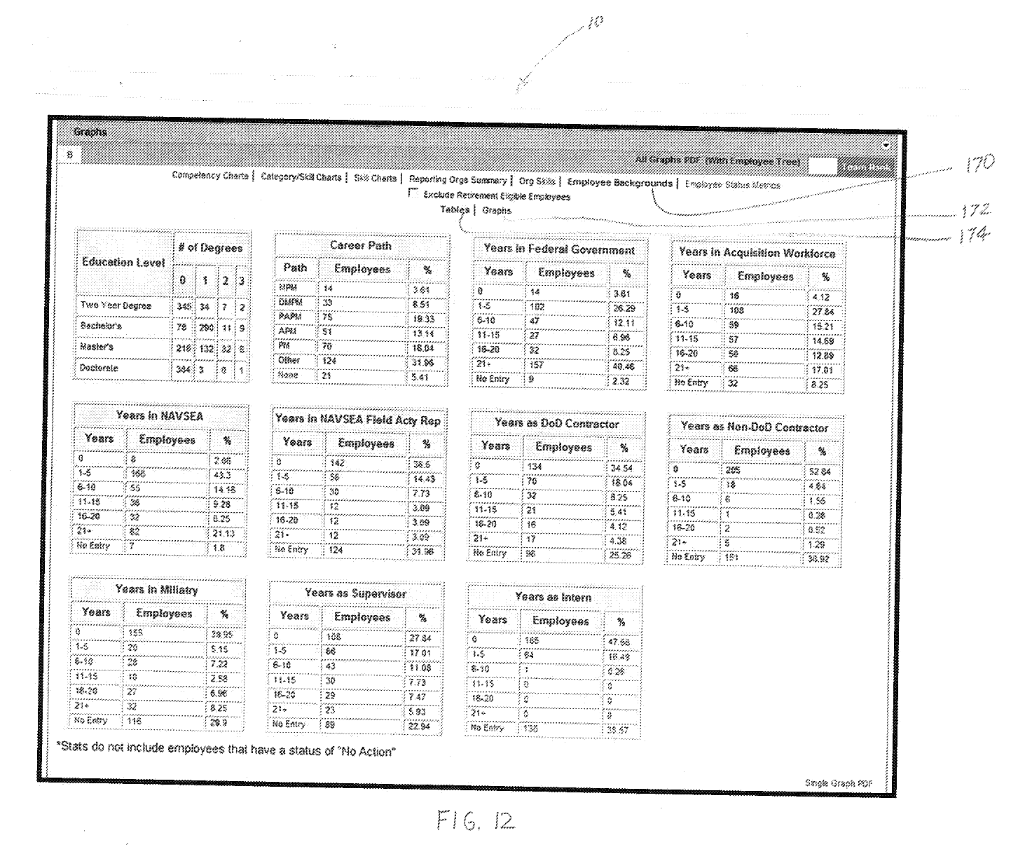

An employee backgrounds report 170 is shown in FIGS. 11-12. The background information may be viewed as a series of graphs by selecting link 172, but may also be displayed in tabular form by selecting link 174, as shown in FIG. 12.

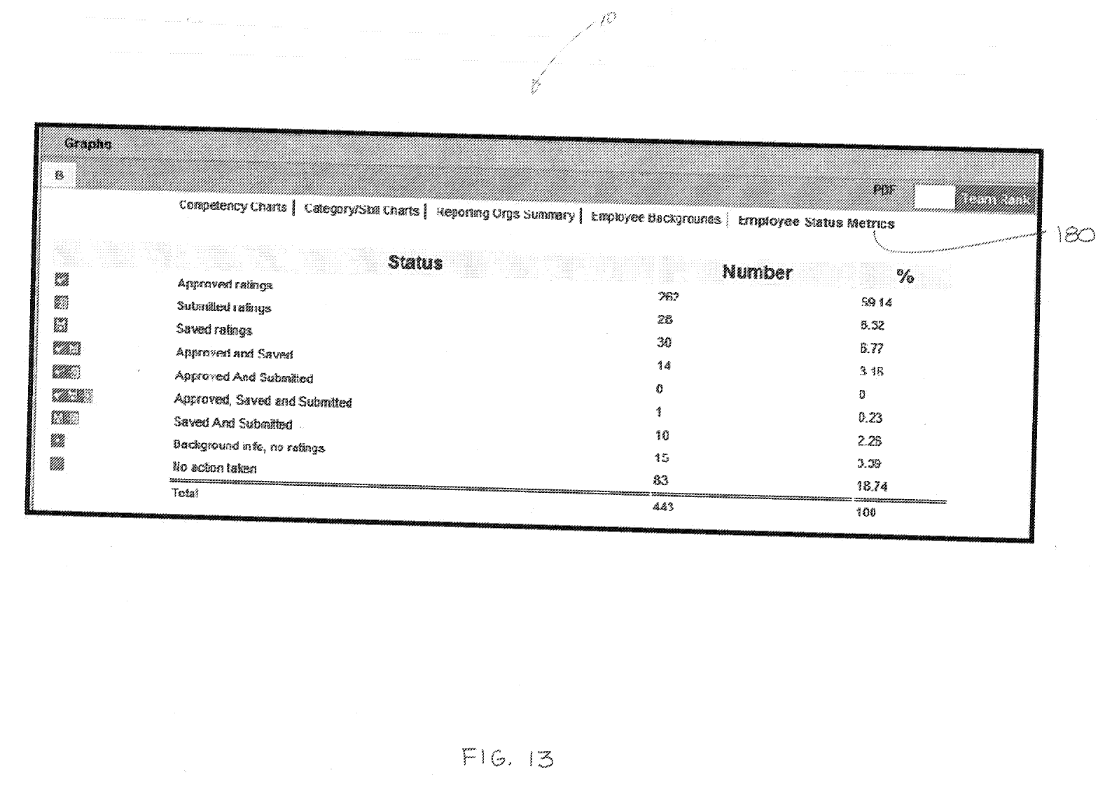

An example display of employee status metrics 180 is shown in FIG. 13. The statistics of how many ratings have been approved, submitted, saved, no action taken etc., in terms of a percentage of the organization are shown.

An overview of the Talent Management Dashboard process is shown in FIG. 8. FIG. 8 shows how workers, both employees and managers, interface with the software, and the processes available to each. FIG. 8 also shows the general system architecture as related to the web interface.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of using a display unit of a computing system for assessing the ability of workers in an organization to accomplish one or more goals of the organization, said method comprising:
defining one or more competencies employees in the organization are required to have;
defining a skill set for each competency, each skill set comprising one or more skills the employees are required to have to carry out each competency;
rating each skill under each competency for each employee;
determining a discrete skill level in each competency for each of the employees; and
displaying a graphic on the display unit which illustrates the proportion of the employees at each discrete skill level.

2. The method according to claim 1, further including determining an overall skill level in each competency.

3. The method according to claim 2, wherein the determining the overall skill level in each competency is made by averaging the skill ratings for all of the employees in the organization under each of the competencies.

4. The method according to claim 1, wherein the determining the discrete skill level in each competency is made by averaging the skill ratings under each of the competencies.

5. The method according to claim 1, further including ranking one of the competencies for each of the employees as a primary competency.

6. The method according to claim 1, wherein the displaying a graphic includes displaying a pie graph to illustrate the proportion of the workers at each discrete skill level.

7. The method according to claim 1, wherein the displaying a graphic includes displaying a bar graph to illustrate the proportion of the workers at each discrete skill level.

8. The method according to claim 1, wherein the displaying a graphic includes displaying the graphic instantly.

9. The method according to claim 2, wherein the displaying a graphic includes a color coded graphic, wherein each the proportion of workers at each discrete skill level are color coded according to a unique color used to designate each discrete skill level.

10. The method according to claim 1, wherein the organization is divided into a group of employees, the group including a manager and subordinates, and the displaying a graphic further includes displaying a graphic illustrating the portion of the employees at each discrete skill level for the group.

11. The method according to claim 1, further including displaying a graphic illustrating the proportion of employees at discrete educational levels.

12. The method according to claim 1, further including displaying a graphic illustrating the proportion of employees at discrete years of service within the organization.

13. A tangible computer readable medium storing computer executable code that when executed by one or more central processing units enables assessing the ability of workers in an organization to accomplish one or more goals of the organization, the computer executable code configured to:
define one or more competencies employees in the organization are required to have;
define a skill set for each competency, each skill set comprising one or more skills the employees are required to have to carry out each competency;
rate at least one skill under each of the competencies for each employee;
determine a discrete skill level in each competency for each employee; and
display a graphic on the display unit which illustrates the proportion of the employees at each discrete skill level.

14. A tangible computer readable medium according to claim 13, wherein the computer executable code is further configured to rank one of the competencies for each of the employees as a primary competency.

15. The tangible computer readable medium according to claim 13, wherein the computer executable code is further configured to determine a numerical average reflecting the skill level in each competency for each employee.

16. The tangible computer readable medium according to claim 13, further configured to display the graphic instantly.

17. A system for assessing the ability of workers in an organization to accomplish one or more goals of the organization, the system comprising:
a control unit comprising a central processing unit configured to execute computer readable code configured to define one or more competencies employees in the organization are required to have; define a skill set for each competency, each skill set comprising one or more skills the employees are required to have to carry out each competency; to rate at least one skill under each of the competencies for each employee, determine a discrete skill level in each competency for each employee, and display a graphic on the display unit which illustrates the proportion of the employees at each discrete skill level, wherein the control unit further comprises a memory unit configured to store data therein retrievable by the central processing unit;
an input device in communication with the control unit configured to accept user supplied data; and
an output device in communication with the control unit configured to display data stored in the memory of the memory unit.

18. The system according to claim 17, wherein the computer readable code is further configured to determine a numerical average reflecting the skill level in each competency for each employee.

19. The system according to claim 17, wherein the computer readable code is further configured to display the graphic instantly.
